(19) United States
(12) Patent Application Publication
(10) Pub. No.: US 2005/0026683 A1
(43) Pub. Date: Feb. 3, 2005

(54) Game management system

(75) Inventor: Jun Fujimoto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 10/889,307

(22) Filed: Jul. 13, 2004

(30) Foreign Application Priority Data
Jul. 17, 2003 (JP) P2003-275717

(51) Int. Cl. A63F 13/00

(52) U.S. Cl. 463/29

(57) ABSTRACT

A game management system includes a plurality of game cards, a game card containing unit, a contained card reading unit, an extracted card reading unit, and a fraud detecting unit. Different pieces of identification information are provided to the respective game media, and the game media are configured to output signals concerning the pieces of identification information. The contained card reading unit reads the signals from the game cards contained in the game card containing unit. The extracted card reading unit reads the piece of identification information of the card which is taken out of the game card containing unit. The fraud detecting unit detects a fraud on the basis of the signals read by the contained card reading unit and the piece of identification information read by the extracted card reading unit.

### CROSS-REFERENCE TO RELATED APPLICATION

This application is based upon and claims the benefit of priority from the prior Japanese Patent Applications No. 2003-275717 filed on Jul. 17, 2003 and U.S. patent application Ser. No. 10/735805 filed on Dec. 16, 2003, the entire contents of which are incorporated herein by reference.

### BACKGROUND OF THE INVENTION

1. Field of the Invention

The present invention relates to a game management system for identifying types of a plurality of game media (such as game cards and game chips). More specifically, the present invention relates to a game management system which is capable of identifying authenticity of the game media at least when the game media are put into a container and when the game media are taken out of the container, and thereby ensuring high reliability of a game and improving credibility of an entire game facility.

2. Related Background of the Invention

In various games using a plurality of game media, for example, game cards are exchanged between a dealer and a player facing each other across a game table, and game chips corresponding to bets are exchanged among players.

A casino hotel is known as a facility for playing such games. For example, as disclosed in Japanese Patent Application Laid-Open No. 2000-357272, a guest who received a house card (such as a certification card which records an identification number for certifying an owner) upon check-in can receive services from various facilities in the casino hotel by using the house card.

In this case, the house card is read out at the cashiers in restaurants and bars in the hotel so that the bills are accumulated in a hotel server. Upon check-out, all the bills are displayed on the terminal at the front desk. In addition, the house card can be utilized in transportation outside the hotel during a stay by connecting the transportation to the hotel via network.

Incidentally, a game charge at a casino is billed separately in conventional casino hotels. Accordingly, the aforementioned house card cannot be utilized to play games. In this case, a hotel guest has to carry a large amount of cash in addition to the house card. As a result, the hotel guest cannot relax in the casino hotel and may encounter a problem such as a theft or a loss.

Moreover, the types of games played in the casino, the amount of money spent therein, and the like are not recorded at all in a history from check-in to check-out, and no guarantees against troubles during that period are offered. Accordingly, it is not possible to develop detailed services.

In addition, all the playing fees in the casino are supposed to be paid in cash in principle and no credit cards are acceptable. Accordingly, when a player becomes too enthusiastic and forgets to end the games, he may not be able to pay the playing fees.

Meanwhile, to prevent a fraud such as fraudulent operation of game cards between a dealer and a player in conspiracy or addition of fraudulent game cards (fraudulent cards such as counterfeited cards or falsified cards: hereinafter referred to as the “fraudulent cards”), in a card game using game cards in a casino, the entire deck of game cards is usually scrapped after completion of one session of the card game and a new deck of cards are used in a subsequent session. In this case, the new deck of cards is put into a card container. The fraudulent cards may be added in this course.

However, a conventional game facility has not been equipped with a system for fraud detection of game cards which are put into card containers (detection of addition of the fraudulent cards). Accordingly, the subsequent game session (the card game) is started without detection even if the fraudulent cards are added in the card container.

Meanwhile, even if the fraudulent cards are not added to the game cards when the game cards are put into the card container, the fraudulent cards may be added when the dealer takes the game cards out of the card container to deal the game cards to the player, for example.

However, the conventional game facility has not been equipped with a system for fraud detection when taking the cards out. Accordingly, the game is continued even if the game cards taken out of the card container are the fraudulent cards. Such a fraud may be occasionally revealed for the first time during the game or at the end of the game.

The reliability of the game is severely damaged if the game is carried out while allowing addition of the fraudulent cards. In addition, the credibility of the entire game facility goes down as well. The above-described fraud is not only limited to the game cards, but may also be committed similarly in a game using game chips, for example.

### SUMMARY OF THE INVENTION

The present invention has been made to solve the foregoing problem, and an object thereof is to provide a game management system which is capable of identifying authenticity of game media at least when the game media are put into containers and when the game media are taken out of the containers, and thereby ensuring high reliability of a game and improving credibility of an entire game facility.

A game management system of the present invention is a game management system for managing. various games carried out by use of game media, which includes (a) a plurality of game media to which different pieces of identification information are assigned respectively and each of which outputs a signal concerning the assigned identification information, (b) game medium containing means for containing the plurality of game media, (c) contained medium reading means for reading the signals from the plurality of game media contained in the game medium containing means, (d) extracted medium reading means for reading the identification information of the game media on the basis of the signal from the game medium extracted from the game medium containing means, and (e) fraud detecting means for detecting a fraud in each game on the basis of the signals read by the contained medium reading means and the identification information read by the extracted medium reading means.

It is preferable that the game management system of the present invention further includes distributed medium reading means for reading the identification information of the game medium which is extracted from the game medium containing means and then distributed to a predetermined destination.

Meanwhile, the game management system of the present invention further includes identification information registering means for registering the pieces of identification information respectively provided to the plurality of game media. The fraud detecting means detects a fraud by checking the identification information, which is read by any of the extracted medium reading means and the distributed medium reading means, against the pieces of identification information registered in the identification information registering means.

In the game management system of the present invention, each of the plurality of game media includes identification information recording means for transmitting a signal formed by modulating a carrier wave having a predetermined frequency and a predetermined intensity with the corresponding identification information. The fraud detecting means can detect a fraud on the basis of comparison of a product of the number of the game media to be contained in the game medium containing means and the predetermined intensity with intensities of the signals read by the contained medium reading means.

Moreover, it is preferable that the game management system of the present invention further includes alarming means for alarming detection of the fraud when the fraud is detected by the fraud act detecting means.

Further, in the game management system of the present invention, the game media at least include game cards for playing a card game, and game chips for representing any of a bet amount and a win-loss amount in a game.

### BRIEF DESCRIPTION OF THE DRAWINGS

FIG. 1 is a block diagram of a casino/hotel system in which a game management system according to one embodiment of the present invention is constructed;

FIG. 2 is a view showing a structure of a game table, which illustrates a state where a card game using a plurality of game cards and game chips is carried out on the game table;

FIG. 3 is a view showing a structure of a game card;

FIG. 4 is a view showing a structure for detecting chip identification information of a game chip;

FIG. 5A is a view showing configurations of a game card containing unit, a contained card reading unit, and an extracted card reading unit, which illustrates a state where all game cards are contained in the game card containing unit;

FIG. 5B is a view showing the configurations of the game card containing unit, the contained card reading unit, and the extracted card reading unit, which illustrates a state where one of the game cards contained in the game card containing unit is extracted onto the extracted card reading unit;

FIG. 6 is a view showing configurations of the contained card reading unit, the extracted card reading unit, and a distributed card reading unit;

FIG. 7 is a view showing configurations of a contained chip reading unit, an extracted chip reading unit, and a distributed chip reading unit;

FIG. 8A and FIG. 8B are views showing examples of tables provided in an identification information registering unit;

FIG. 9A is a view schematically showing all histories of the game cards managed by a player tracking system (PTS) server;

FIG. 9B is a view schematically showing all histories of the game chips managed by the PTS server; and

FIG. 10 is a view showing an example of data concerning histories of movements of the cards which are registered with the PTS server.

### DESCRIPTION OF THE PREFERRED EMBODIMENTS

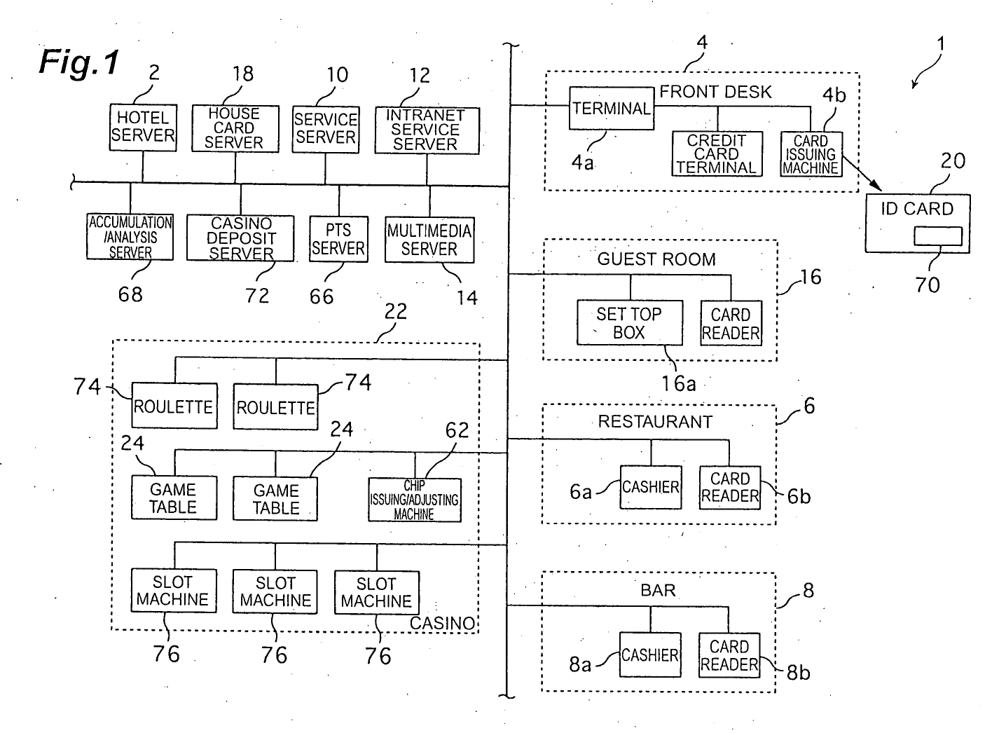

Now, a preferred embodiment of the present invention will be described with reference to the accompanying drawings. FIG. 1 is a block diagram of a casino/hotel system including a construction for a game management system of this embodiment.

In the casino/hotel system shown in FIG. 1, various functions for performing, integrated management of a terminal 4a at a front desk 4, cashiers 6a and 8a at a restaurant 6 and a bar 8a, and the like are constructed for a hotel server 2. Various functions for performing reservation and ticketing of various shows and events held in the hotel are constructed for a service server 10. Functions for managing the intranet in the hotel are constructed for an intranet service server 12. Functions corresponding to video-on-demand and game-on-demand services for a set top box 16a in a guest room 16 are constructed for a multimedia server 14.

Various functions for performing management of a ID card 20 (a card which can identify a guest staying at the hotel) which is called a house card, management of an individual account, and the like are constructed for a house card server 18. When a guest checks in the casino/hotel, a card issuing machine 4b at the front desk 4 issues the ID card (the house card) 20 for specifying the guest. Thereafter, it is possible to use all the facilities in the casino/hotel by showing the ID card 20 for checking. For example, bills are accumulated in the hotel server 2 by reading the ID card 20 with card readers 6b and 8b of the cashiers 6a and 8a at the restaurant 6 and the bar 8 in the hotel, and all the bills are displayed on the terminal 4a at the front desk 4 when checking out. That is, the ID card 20 can be linked to various management systems to be described later in addition to the game management system. In this context, the ID card 20 at least functions as a credit card when purchasing goods or paying for food and drinks.

Various functions for managing various games played on respective game tables 24 in a casino 22 are constructed for the above-described game management system 1 in the casino/hotel system.

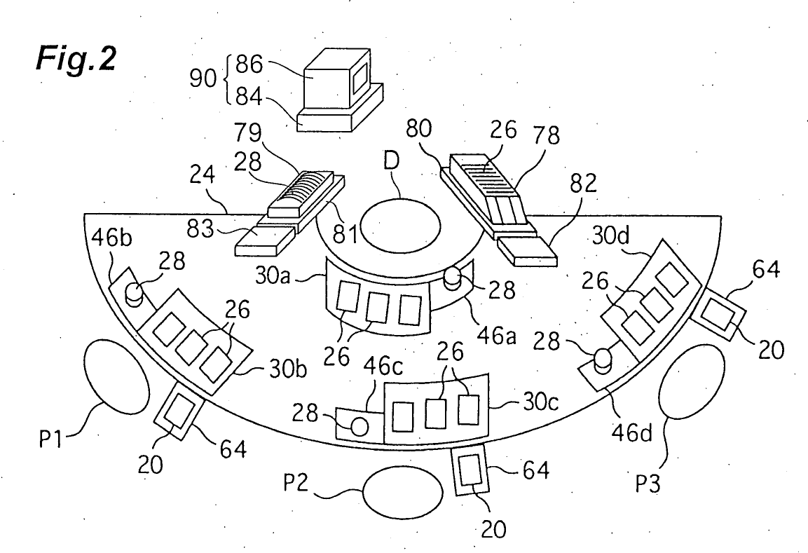

FIG. 2 is a view showing a structure of a game table, which illustrates a state where a card game using a plurality of game cards and game chips is carried out on the game table. In the following explanation, as shown in FIG. 2, an assumption is made that the card game is carried out on a game table 24 by use of a plurality of game media such as a plurality of game cards 26 for playing the card game and game chips 28 for representing a bet amount or a win-loss amount in the game.

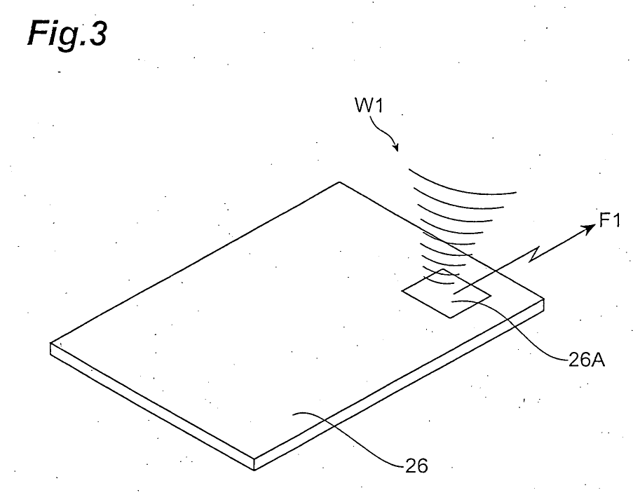

FIG. 3 is a view showing a structure of a game card. In this embodiment, ordinary playing cards are applied as the game cards. Each of the plurality of playing cards, that is, the plurality of game cards 26, is provided with a card identification information recording unit 26A. Different pieces of card identification information are assigned to the card identification information recording units 26A so as to identify the respective game cards 26. The card identification information recording unit 26A records the card identification information and outputs a signal concerning the card identification information. In this embodiment, the card identification information recording unit 26A is made of an integrated circuit (IC) tag. Accordingly, the card identification information recording unit 26A is configured to respond to a radio wave W1 transmitted from a device for reading the card identification information, and to transmit a signal F1 which is formed by modulating a carrier wave having a predetermined frequency f1 and a predetermined intensity with the card identification information.

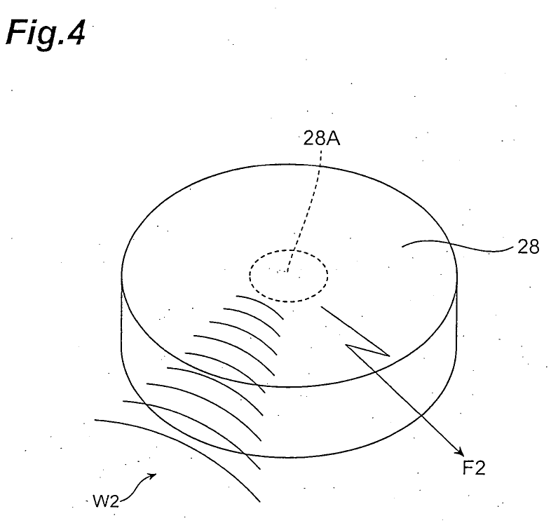

FIG. 4 is a view showing a structure of a game chip. Each of the plurality of game chips 28 is provided with a chip identification information recording unit 28A. Different pieces of chip identification information are assigned to the chip identification information recording units 28A so as to identify the respective game chips 28. The chip identification information recording unit 28A records the chip identification information and outputs a signal concerning the chip identification information. In this embodiment, the chip identification information recording unit 28A is made of a very small wireless IC tag. The card identification information recording unit 26A is configured to respond to a radio wave W2 transmitted from a device for reading the chip identification information, and to transmit a signal F2 which is formed by modulating a carrier wave having a predetermined frequency and a predetermined intensity with the chip identification information and value information for specifying a value (such as 1 dollar, 5 dollars or 10 dollars) of the game chip 28.

The game management system 1 for managing the game using these game media are provided with game medium containing units, contained medium reading units, extracted medium reading units, and distributed medium reading units.

The game medium containing units include a game card containing unit 78 and a game chip containing unit 79. The contained medium reading units include a contained card reading unit 80 and a contained chip reading unit 81. The extracted medium reading units include an extracted card reading unit 82 and an extracted chip reading unit 83. The distributed medium reading units include distributed card reading units 30a, 30b, 30c, and so on, and distributed chip reading units 46a, 46b, 46c, and so on. In the following explanation, the distributed card reading units 30a, 30b, 30c, and so on may be collectively referred to as the distributed card reading units 30, and the distributed chip reading units 46a, 46b, 46c, and so on may be collectively referred to as the distributed chip reading units 46.

As shown in FIG. 2, the game card containing unit 78, the game chip containing unit 79, the contained card reading unit 80, the contained chip reading unit 81, the extracted card reading unit 82, the extracted chip reading unit 83, the distributed card reading unit 30a, and the distributed chip reading unit 46a are provided in the vicinity of a dealer seat D of the game table 24. The distributed card reading units 30b, 30c, 30d, and so on, and the distributed chip reading units 46b, 46c, 46d, and so on are respectively disposed in the vicinities of participant seats P1, P2, P3, and so on for participants of the game. These reading units are connected to a computer 90 provided in the vicinity of the dealer seat D.

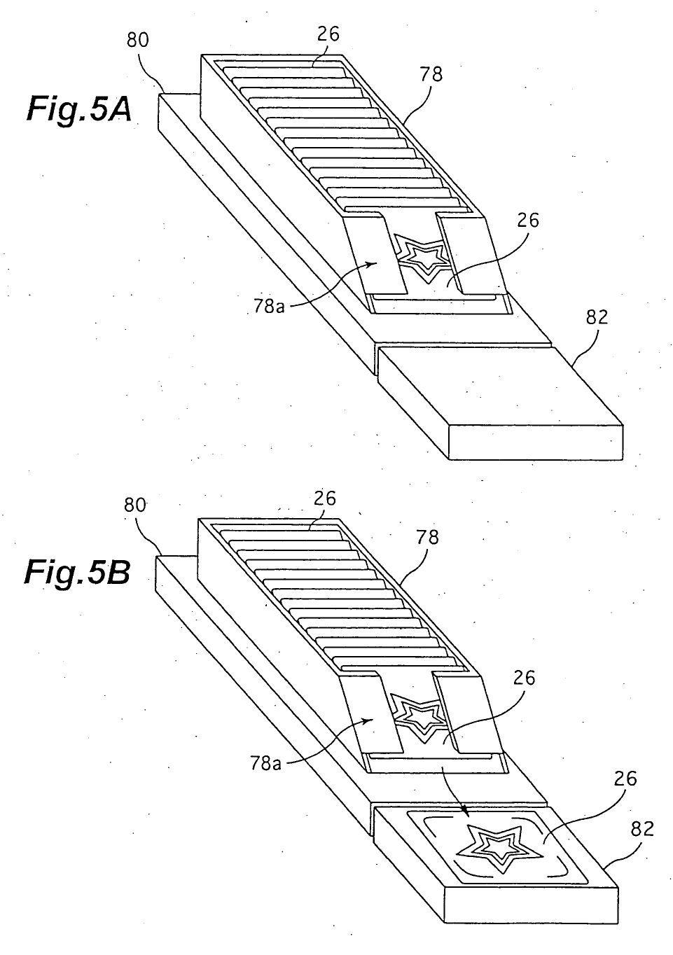

FIG. 5A is a view showing configurations of the game card containing unit, the contained card reading unit, and the extracted card reading unit, which illustrates a state where all game cards are contained in the game card containing unit. FIG. 5B is a view showing the configurations of the game card containing unit, the contained card reading unit, and the extracted card reading unit, which illustrates a state where one of the game cards contained in the game card containing unit is extracted onto the extracted card reading unit.

As shown in FIG. 5A and FIG. 5B, the game card containing unit 78 of this embodiment is a container box for containing the game cards. The contained card reading unit 80 is provided immediately below the game card containing unit 78, and the extracted card reading unit 82 is provided in front of an outlet 78a of the game card containing unit 78. At the start of the game, all the game cards 26 are firstly put into the game card containing unit 78, and the game cards 26 taken out of the outlet 78a overpass the extracted card reading unit 82 and are distributed to a dealer or participants of the game. The game cards distributed to the dealer or the participants of the game are placed on the corresponding distributed card reading units 30.

Meanwhile, the game chip containing unit 79 of this embodiment is a container box for containing the game chips similarly. The contained chip reading unit 81 is provided immediately therebelow, and the extracted chip reading unit 83 is provided in front thereof. At the start of the game, the game chips 28 are firstly put into the game chip containing unit 79, and the game chips 28 taken out of the game chip containing unit 79 overpass the extracted chip reading unit 83 and are distributed to the dealer or the participants of the game. The game chips distributed to the dealer or the participants of the game are placed on the corresponding distributed chip reading units 46.

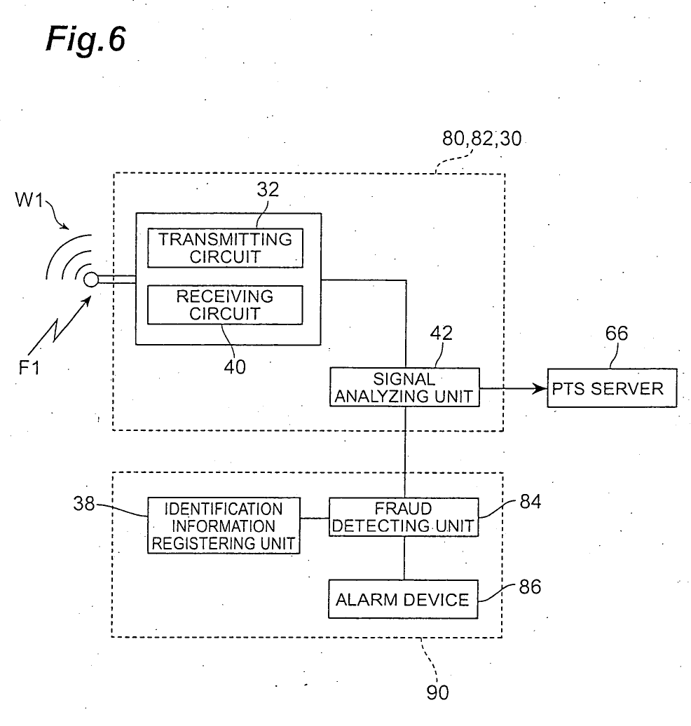

FIG. 6 is a view showing configurations of the contained card reading unit, the extracted card reading unit, and the distributed card reading unit. As shown in FIG. 6, each of the contained card reading unit 80, the extracted card reading unit 82, and the distributed card reading unit 30 adopts a similar configuration including a transmitting circuit 32, a receiving circuit 40, and a signal analyzing unit 42.

The transmitting circuit 32 transmits the radio wave W1 at predetermied timing. The receiving circuit 40 receives the signal F1 from the identification information recording unit 26A of the game card 26 in response to the radio wave W1. The signal analyzing unit 42 analyzes the signal F1 received by the receiving circuit 40. Here, the signal analyzing unit 42 of the contained card reading unit 80 has a different function from the signal analyzing units 42 of the extracted card reading unit 82 and of the distributed card reading unit 30.

The signal analyzing unit 42 of the contained card reading unit 80 detects the intensity of the received signal F1 and outputs intensity information indicating the intensity and an identification (ID) of the contained card reading unit 80, which is a sender of the information, to the computer 90 and to a player tracking system (PTS) server 66. That is, a total value of the intensities of the signals F1 from all the card identification information recording units 26A contained in the game card containing unit 78 is outputted to the computer 90 as the intensity information. On the other hand, the signal analyzing unit 42 of each of the extracted card reading unit 82 and the distributed card reading unit 30 extracts the card identification information by demodulating the signal F1 and outputs the card identification information and the ID for specifying the own device which is the sender of the information to the computer 90 and to the PTS server 66.

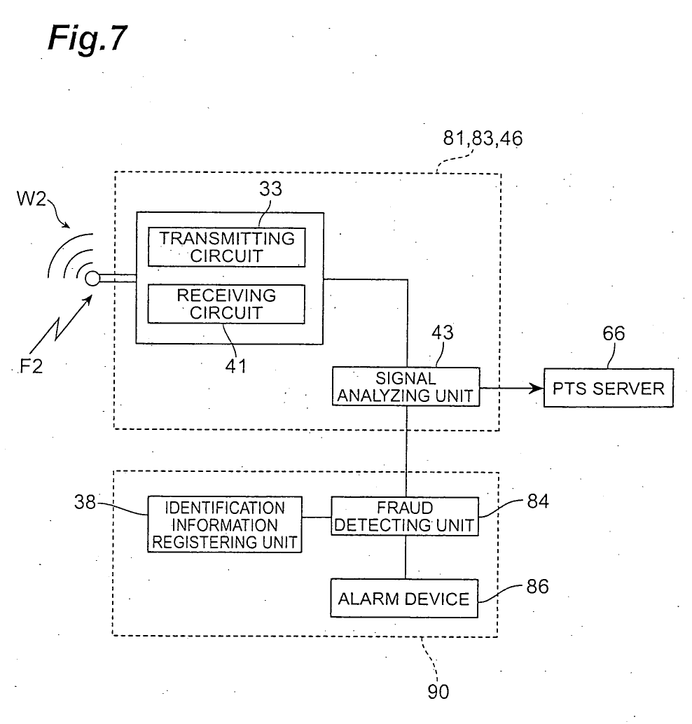

FIG. 7 is a view showing configurations of the contained chip reading unit, the extracted chip reading unit, and the distributed chip reading unit. Each of the contained chip reading unit 81, the extracted chip reading unit 83, and the distributed chip reading unit 46 adopts a similar configuration including a transmitting circuit 33, a receiving circuit 41, and a signal analyzing unit 43.

The transmitting circuit 33 transmits the radio wave W2 at predetermined timing. The receiving circuit 41 receives the signal F2 from the identification information recording unit 28A of the game chip 28 corresponding to the radio wave W2. The signal analyzing unit 43 analyzes the signal F2 received by the receiving circuit 41. Here, the signal analyzing unit 43 of the contained chip reading unit 81 has a different function from the signal analyzing units 43 of the extracted chip reading unit 83 and of the distributed chip reading unit 46.

The signal analyzing unit 43 of the contained chip reading unit 81 detects the intensity of the received signal F2. The contained chip reading unit 81 includes a weight sensor (not shown) for measuring a total weight of the chips contained in the game chip containing unit 79. The signal analyzing unit 43 outputs intensity information indicating the intensity, weight information indicating the total weight, and an ID of the own device to the computer 90 and to the PTS server 66. That is, a total value of the intensities of the signals F2 from all the chip identification information recording units 28A contained in the game chip containing unit 79 is outputted to the computer 90 as the intensity information. On the other hand, the signal analyzing unit 43 of each of the extracted chip reading unit 83 and the distributed card reading unit 46 extracts the chip identification information and the value information by demodulating the signal F2 and outputs the chip identification information, the value information, and the ID of the own device to the computer 90 and to the PTS server 66.

The computer 90 includes a main body provided with a central processing unit (CPU), a memory, a hard disk, and the like, and a display unit. The main body constitutes a fraud detecting unit 84 for detecting a fraud, and the display unit functions as an alarm device 86 in case of detection of the fraud.

The fraud detecting unit 84 detects whether or not a fraudulent game card is put into the game card containing unit 80 on the basis of the intensity information from the contained card reading unit 80. To be more precise, at the start of the game, the fraud is detected on the basis of comparison between a product of the number of the game cards supposed to be put into the game card containing unit 78 and the predetermined intensity, and, the intensity information outputted from the contained card reading unit 80. For example, when a game card not having the card identification information unit 26A is fraudulently put therein, the intensity specified by the intensity information is different from the product. Upon detection of such a difference, the fraud detecting unit 84 activates the alarm device 86 and alarms occurrence of the fraud.

Meanwhile, the fraud detecting unit 84 detects whether or not a fraudulent game chip is put into the game chip containing unit 79 on the basis of the intensity information from the contained chip reading unit 81 and on the weight information. To be more precise, the fraud detecting unit 84 detects the fraud in the following manner: calculate the total number of the game chips on the basis of the weight specified by the weight information, and detect the difference between a product of the total number and the predetermined intensity of the signal F2, and, the intensity specified by the intensity information. Upon detection of the fraud, the fraud detecting unit 84 activates the alarm device 86 and alarms occurrence of the fraud.

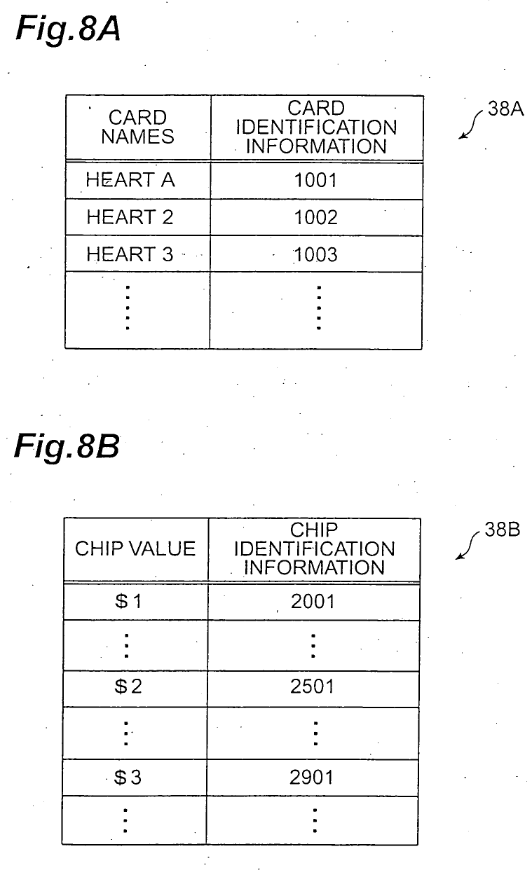

An identification information registering unit 38 is connected to the fraud detecting unit 84. FIG. 8A and FIG. 8B are views showing examples of tables provided in the identification information registering unit 38. As shown in FIG. 8A and FIG. 8B, the identification information registering unit 38 includes a first table 38A and a second table 38B. Data linking card names to the card identification information of the cards are registered with the first table 38A. Data linking chip values to the chip identification information of the chips are registered with the second table 38B.

When the card identification information outputted from the extracted card reading unit 82 and the distributed card reading unit 30 is not registered with the first table 38A provided in the identification information registering unit 38, the fraud detecting unit 84 activates the alarm device 86 to alarm the occurrence of the fraud.

Meanwhile, when the chip identification information outputted from the extracted chip reading unit 83 and the distributed chip reading unit 46 is not registered with the second table 38B provided in the identification information registering unit 38, the fraud detecting unit 84 activates the alarm device 86 to alarm the occurrence of the fraud.

The game management system 1 further includes management section (the PTS server 66, an accumulation/analysis server 68, and a casino deposit server 72) which are capable of managing at least histories and results of the various games to be carried out on the game tables 24 on the basis of the card identification information and the chip identification information.

In the game management system 1, a person who wishes to play the card game in the casino 22 (FIG. 1) enters the casino with the above-described ID card 20 and obtains desired pieces of the game chips 28 from a game chip exchanger machine 62. Then, the person sets the ID card 20 on a reading unit 64 of the game table 24. At this time, the reading unit 64 read the contents of the ID card 20 and specifies and recognizes the person as a participant. Data recognized by the reading unit 64 are transmitted to the PTS server 66 for registering the person as the participant in a current game. Here, the reading unit can be set up (in a magnetic reading method or an optical reading method) arbitrarily in response to a recording method (such as magnetic recording or optical recording) of the ID card 20.

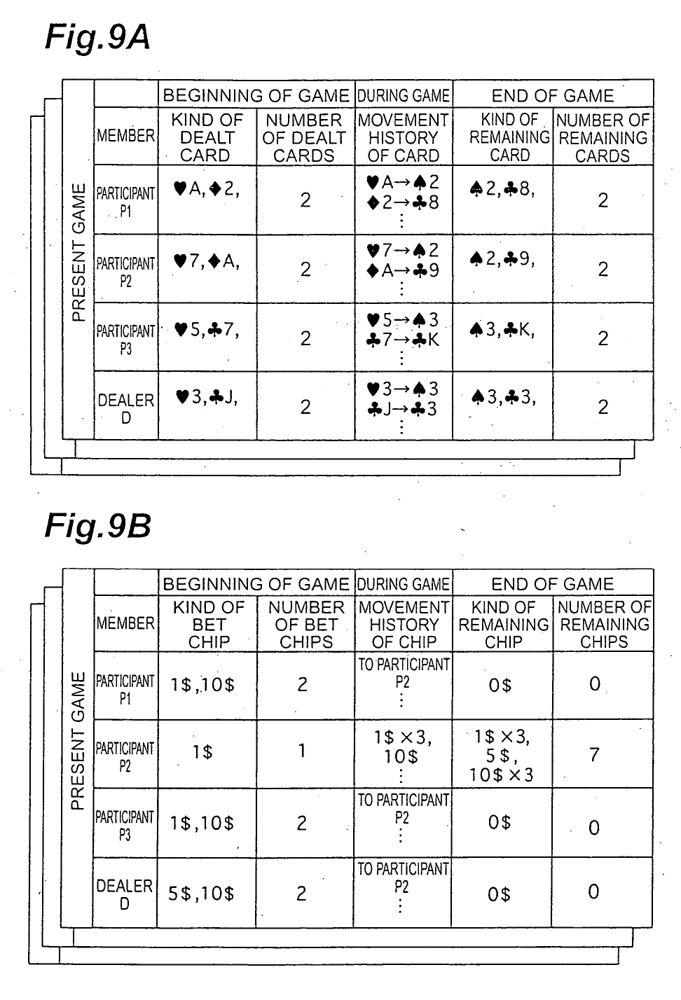

FIG. 9A is a view schematically showing all histories of the game cards managed by the PTS server. Meanwhile, FIG. 9B is a view schematically showing all histories of the game chips managed by the PTS server. The card identification information of the game cards 26 is read out before starting the game, at the start of the game, in the course of the game, and at the end of the game by the contained card reading unit 80, the extracted card reading unit 82, and the distributed card reading units 30a, 30b, 30c, 30d, and so on, and the card identification information is transmitted to the PTS server 66 and is registered with a table provided in the PTS server 66 (see FIG. 9A).

Firstly, before staring the game, when the plurality of game cards (such as the playing cards consisting of 54 cards) 26 are put into the game card containing unit 78 which is game medium containing means, the signals F1 from all the game cards 26 in the game card containing unit 78 are read by the contained card reading unit 80. At this time, if there is a fraud such as a fraudulent operation of the game cards 26 or addition of a fraudulent card by the dealer and the participant in conspiracy, such a fraud is detected by the fraudulent act detecting unit 84 and is alarmed by the alarm device 86.

For example, when a fraudulent card not including an IC tag (a fraudulent game card) is added thereto, no signal is detected from the fraudulent card. Accordingly, existence of the fraud is detected by such a detection result.

In this way, it is possible to detect the fraud committed before staring the game by detecting the total value of the intensities of the signals F1 from the respective game cards 26 at the time of putting the plurality of game cards (such as the playing cards consisting of 54 cards) 26 into the game card containing unit 78. As a result, it is possible to ensure high reliability of the game and to improve credibility of the entire game facility.

Next, at the start of the game (immediately before starting the game), the identification information of the game cards 26 is read by the extracted card reading unit 82 immediately after the game cards 26 are taken out one by one from the outlet 78a.

For example, when the fraudulent card not including the IC tag is taken out of the game card containing unit 78, no signal is detected from the fraudulent card. Accordingly, the fraud detecting unit 84 detects occurrence of the fraud immediately before starting the game (fraudulent addition of the fraudulent card into the game card containing unit 78) on the basis of such a detection result. Meanwhile, when the card identification information extracted from the signal F1 transmitted from the IC tag of the game card taken out of the game card containing unit 78 is not registered with the identification information registering unit 38, for example, the fraud detecting unit 84 detects occurrence of the similar fraud.

In this way, it is possible to detect the fraud (to identify authenticity of the game cards, for example) committed immediately before staring the game by detecting the respective pieces of card identification information of the game cards 26 immediately after taking the cards 26 out of the game card containing unit 78. As a result, it is possible to ensure high reliability of the game and to improve credibility of the entire game facility.

In addition, at the start of the game (immediately after starting the game), the game cards 26 taken out of the game card containing unit 78 are subjected to checking whether or not the cards are distributed to predetermined destinations. The predetermined destinations in this case include the dealer and the respective participants. The identification information of these game cards 26 distributed to the destinations is read out by the distributed card reading unit 30a disposed in the vicinity of the dealer seat D of the game table 24 and by the distributed card reading units 30b, 30c, and 30d disposed in the vicinities of the participant seats P1, P2, and P3, respectively.

In this case, if the fraudulent card not including the IC tag is distributed to any of the distributed card reading units 30a, 30b, 30c, and 30d, no signal is detected from the fraudulent card. Accordingly, the fraud detecting unit 84 detects occurrence of the fraud immediately after starting the game on the basis of such a detection result. Meanwhile, when the signal F1 from the game card distributed to the destination does not coincide with the card identification information registered with the identification information registering unit 38, for example, the fraud detecting unit 84 detects occurrence of the similar fraud. Here, the fraud may include addition of the fraudulent card immediately after starting the game, a failure to distributing the game cards 26 in the correct order, distribution of the fraudulent card to the destination, and the like.

In this way, it is possible to detect the fraud (to identify authenticity of the game cards, for example) committed immediately after starting the game by detecting the respective pieces of card identification information of the game cards 26 when distributing the game cards 26. As a result, it is possible to ensure high reliability of the game and to improve credibility of the entire game facility.

Next, in the course of the game, histories of movements of the game cards 26 exchanged between the dealer and the participants are sequentially read by the respective distributed card reading units 30a, 30b, 30c, and 30d. Data thus read out are transmitted to the PTS server 66. That is, routes and directions of movements of the game cards 26, and the fraud in the course of the game can be read out easily and accurately only by passing the game cards 26 through the respective distributed card reading units 30a, 30b, 30c, and 30d.

The fraud in this case may include addition of the fraudulent card in the course of the game, improper exchange of the game cards 26 between the dealer and the participant, exchange of the fraudulent card, and the like.

In this way, it is possible to detect the fraud (to identify authenticity of the game cards exchanged between the dealer and the participant, for example) committed in the course of the game by detecting the respective pieces of card identification information of the game cards 26 in the course of the game. As a result, it is possible to ensure high reliability of the game and to improve credibility of the entire game facility.

At the end of the game, the types and the number of the remaining game cards 26 are detected on the basis of the card identification information read by the respective distributed card reading units 30a, 30b, 30c, and 30d. Further, the card identification information is transmitted to the PTS server 66.

For example, when the fraudulent card not including the IC tag are remained, no signal is detected from the fraudulent card by any of the distributed card reading units 30a, 30b, 30c, and 30d. Accordingly, the fraud detecting unit 84 detects occurrence of the fraud at the end of the game on the basis of such a detection result. Meanwhile, when the card identification information from the IC tag of the remaining game card is not registered with the identification information registering unit 38, for example, the fraud detecting unit 84 detects occurrence of the similar fraud.

In this way, it is possible to detect the fraud (to identify authenticity of the remaining game card, for example) committed at the end of the game by detecting the respective pieces of card identification information of the game cards 26 at the end of the game. As a result, it is possible to ensure high reliability of the game and to improve credibility of the entire game facility.

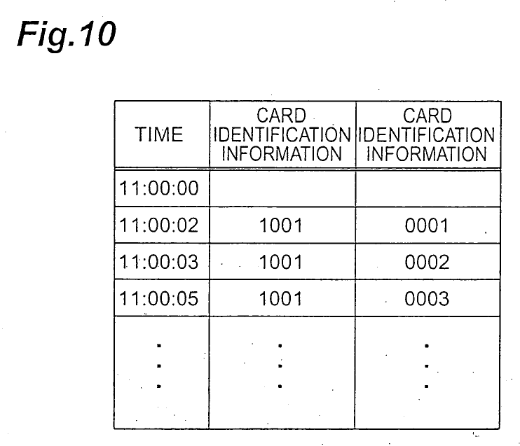

As described above, all the histories of the game cards 26 before stating the game, at the start of the game, in the course of the game, and at the end of the game are sequentially registered with the PTS server 66 and are integrally managed by the counting-analyzing server 68. FIG. 10 is a view showing an example of data concerning the histories of movements of the cards which are registered with the PTS server. For example, as shown in FIG. 10, the histories of movements of the game cards are registered with the PTS server as the data linking the time when the game card is read by each of the reading units, the card identification information of the game card, and the ID of the reading unit which read the card identification information of the game card together. Here, in FIG. 10, a piece of data registering only the time indicates the time when starting the game, which registers only the time when all the game cards are put into the game card containing unit 78.

Moreover, when the fraud is detected by the fraud detecting unit 84 before starting the game, at the start of the game, in the course of the game, or at the end of the game, the occurrence of the fraud is alarmed by the alarm device 86. An alarming method in this case may be to generate an alarm beep for notifying people of the occurrence of the fraud, or to transmit an alarm signal indicating the occurrence of the fraud to the accumulation-analysis server 68 via the PTS server 66, for example.

Meanwhile, at the time before starting the game, at the start of the game, in the course of the game, and at the end of the game as described above, the distributed chip reading units 46a, 46b, 46c, and 46d read the values (such as 1 dollar, 5 dollars, or 10 dollars) and the chip identification information (numbers for identifying the game chips) of the game chips 28 (FIG. 9B) which are bet in the card game in order to detect the fraud. As a result, it is possible to quickly and accurately calculate the types, the number, and the amount of the game chips 28 which are won at the end of the game. All these data are sequentially registered with the PTS server 66 and are integrally managed by the accumulation/analysis server 68 from the start to the end of the game.

In this case as well, it is needless to say that the fraud is detected by the fraud detecting unit 84 and is alarmed by the alarm device 86 before starting the game, at the start of the game, in the course of the game, and at the end of the game as similar to the game cards 26 described above.

In the above-described embodiment, the game chips 28 are bet directly. However, since the ID card 20 includes a deposit checking unit 70 (FIG. 1) for checking the amount of deposit of the user, the user can play various games, i.e. the card games in response to a checking result performed by the deposit checking unit 70 instead of using the game chips 28. In this case, the participant can bet arbitrary amounts of money by use of an unillustrated bet input device (such as a numeric key pad) in hand. Then, all the bet amounts are sequentially registered with the PTS server 66 as similar to the game chips 28 as described above, and are integrally managed by the accumulation/analysis server 68. Here, the deposit in the casino is integrally managed by the casino deposit server 72 (FIG. 1). Accordingly, it is possible to update the deposit balance in accordance with a score as a result of the game, and to pay for an additional deposit, and the like without cash.

As described above, according to the game management system of this embodiment, it is possible to detect or prevent the fraud beforehand by reading the respective pieces of identification information (the card identification information and the chip identification information) of the game media (the game cards 26 and the game chips 28) at the respective stages before starting the game, at the start of the game, in the course of the game, and at the end of the game, especially at the stage when it has been easy to plot the fraud (before starting the game and in the course of the game, in particular) in the past. As a result, it is possible to achieve the game management system which can ensure high reliability of the game and to improve credibility of the entire game facility.

Moreover, according to the embodiment, it is possible to manage all the histories of the game cards 26 and the game chips 28 from the start to the end of the game, and thereby to eliminate fraudulent games or fraudulent operations which might occur in the past. To be more precise, the histories of the respective game cards 26 and the game chips 28 are always monitored. Accordingly, even when a counterfeit card or a counterfeit chip is added in the course of the game, it is possible to find out addition of such a counterfeit and thereby to eliminate fraudulent games. Moreover, even when the game cards 26 are fraudulently operated between the dealer and the participant in conspiracy, it is possible to accurately grasp the time of such a fraudulent operation and a flow of the game cards 26 on the basis of the histories of the game cards 26 detected by the distributed card reading units 30. In this way, it is possible to eliminate fraudulent operations.

Furthermore, according to this embodiment, a guest can use all the facilities in the hotel with the ID card (the house card) 20 which the guest obtained when checking in. Therefore, it is possible to develop detailed services which were unavailable in the past. Particularly, since the playing fees in the casino have been conventionally charged in a separate account, a casino user would find it too much trouble to manage cash on his own. However, it is possible to pay out in a lump sum when checking out by use of the ID card 20, and thereby possible to reduce a burden on the casino user. In addition, it is possible to avoid addiction to the games by use of a deposit function of the ID card 20. In this way, it is possible to avoid an excessive loss and to enjoy the games safely.

Although it has not been particularly described herein, it is also possible to play gaming machines located in the casino 22, such as roulettes 74 or slot machines 76 by use of the ID card 20. Game histories of these machines can be also registered with the PTS server 66 for the purpose of integral management.

As described in the preferred embodiment, according to the present invention, it is possible to achieve the game management system which is capable of identifying authenticity of the game media (reading the identification information of the game media) at least when the game media are put into containers and when the game media are taken out of the containers, and thereby ensuring high reliability of games and improving credibility of an entire game facility.

1. A game management system for managing various games carried out by use of game media, comprising:
a plurality of game media to which different pieces of identification information are assigned respectively and each of which outputs a signal concerning the assigned identification information;
game medium containing means for containing the plurality of game media;
contained medium reading means for reading the signals from the plurality of game media contained in the game medium containing means;
extracted medium reading means for reading the identification information of the game medium on the basis of the signal from the game medium extracted from the game medium containing means; and
fraud detecting means for detecting a fraud in each game on the basis of the signals read by the contained medium reading means and the identification information read by the extracted medium reading means.

2. The game management system according to claim 1, further comprising:
distributed medium reading means for reading the identification information of the game medium which is extracted from the game medium containing means and then distributed to a predetermined destination.

3. The game management system according to claim 2, further comprising:
identification information registering means for registering the pieces of identification information respectively provided to the plurality of game media,
wherein the fraud detecting means detects a fraud by checking the identification information, which is read by any of the extracted medium reading means and the distributed medium reading means, against the pieces of identification information registered in the identification information registering means.

4. The game management system according to claim 1,
wherein each of the plurality of game media comprises identification information recording means for recording the identification information and transmitting a signal formed by modulating a carrier wave having a predetermined frequency and a predetermined intensity with the identification information, and
the fraud detecting means detects a fraud on the basis of comparison of a product of the number of the game media to be contained in the game medium containing means and the predetermined intensity with intensities of the signals read by the contained medium reading means.

5. The game management system according to claim 1, further comprising:
alarming means for alarming detection of the fraud when the fraud is detected by the fraud detecting means.

6. The game management system according to claim 1,
wherein the game media at least include game cards for playing a card game, and game chips for representing any of a bet amount and a win-loss amount in a game.
